(19) United States
(12) Patent Application Publication
(10) Pub. No.: US 2003/0094401 A1
(43) Pub. Date: May 22, 2003

(54) Screening device

(75) Inventors: Anders Bergdahl, Sundsbruk (SE); Lennart Svensson, Sundsvall (SE)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Metso Paper, Inc., Sundsvall (SE)

(21) Appl. No.: 10/166,416

(22) Filed: Jun. 10, 2002

Related U.S. Application Data
(63) Continuation-in-part of application No. PCT/SE02/00881, filed on May 8, 2002.

(30) Foreign Application Priority Data
May 11, 2001 (SE) 0101691-4

(51) Int. Cl. B01D 21/02; B07B 1/04; B01D 21/18; B01D 33/58; D21B 1/00; B01D 35/00; B01D 25/32; B07B 1/49

(52) U.S. Cl. 209/273; 209/406; 210/415; 162/1

(57) ABSTRACT

A screening basket is disclosed which is intended to be located in a screening device for separating a fibrous suspension. The screening basket is tubular with a diameter and an effective screening height. In order to reduce problems with thickening and wear, the diameter is at least 1.8 times greater than the effective screening height.

### CROSS-REFERENCE TO RELATED APPLICATIONS

The present application is a continuation-in-part of International Application No. PCT/SE02/00881, filed on May 8, 2002, the disclosure of which is incorporated by reference herein.

### FIELD OF THE INVENTION

The present invention relates to a tubular screen intended for use in a screening device for the separation of fibrous suspensions, preferably pulp suspensions.

### BACKGROUND OF THE INVENTION

A typical screening device for use in the separation of fibrous suspensions can comprise a pressurized screen housing with a chamber, in which the screening means is located. A rotary rotor is mounted on a rotor shaft inside of the screening means, and the rotor suitably comprises a pulse transducing element of some kind, such as wings or buckles.

The screening means divides the interior of the screen housing in a radial direction into an accept chamber located outside the screening means and a screen chamber located inside the screening means.

The screening device further comprises inlet means for the supply of a fibrous suspension to the screening device, at least one reject outlet means for reject from the screening device and at least one accept outlet means for accept from the screening device. The pulp suspension to be screened is introduced through the inlet means to the screen chamber, where the accepted fraction (the accept) flows through the screening means into the accept chamber.

During rotation of the rotor means the pulse transmitting elements create pulses, which assist in moving the accept through the screening means.

In screening devices of this kind problems arise with the thickening of the pulp at one end of the screening means; namely, the reject end. The pulp passing along the screening means is dewatered and thereby thickened as it passes along the screening means in a direction towards the reject outlet.

This thickening causes a deteriorated functioning of the screening means, owing, among other reasons, to an increase of the friction between the rotor and screening means. In the worst case the rotor can come to a complete standstill.

The thickening also causes wear. When abrasive components, for example sand, are included in the pulp suspension, the screening means and/or pulse transmitting means can be worn down very rapidly.

For solving these problems, one attempted solution has been to supply dilution water in order to dilute the pulp suspension in the area where the thickening reaches a troublesome magnitude.

It has also been attempted to develop different types of rotor wings intended to assist in decreasing the thickening process.

In screening means known in the art, the diameter of the screening means is generally about 1 to 1.5 times greater than its height.

### SUMMARY OF THE INVENTION

In accordance with the present invention, these and other objects have been realized by the invention of apparatus for use in screening devices for separating a fibrous suspension, the apparatus comprising a tubular screen having a predetermined diameter and an effective screening height, the predetermined diameter being at least 1.8 times greater than the effective screening height. In one embodiment, the predetermined diameter is at least 2 times greater than the effective screening height. In another embodiment, the predetermined diameter is from 2.5 to 5 times greater than the effective screening height. Preferably, the predetermined diameter is at least 3 times greater than the effective screening height, and more preferably, is at least 4 times greater than the effective screening height.

In accordance with one embodiment of the apparatus of the present invention, the tubular screen includes a surface and a predetermined height, and the tubular screen includes partial blinding means for covering a portion of the surface of the tubular screen whereby the predetermined height is greater than the effective screening height. Preferably, the partial blinding means comprises an integral solid portion of the tubular screen which does not include any screen apertures. In another embodiment, the partial blinding means is welded to the outside surface of the tubular screen. In yet another embodiment, the partial blinding means is welded to the inside surface of the tubular screen.

In accordance with the present invention, apparatus has also been devised for separating a fibrous suspension comprising a screen housing, a tubular screen disposed within the screen housing, a rotatable rotor disposed within the screen housing for rotation therein, the rotatable rotor including pulsing means for providing pulses of the fibrous suspension to the tubular screen, inlet means for providing the fibrous suspension to the rotatable rotor, and outlet means for an accept portion of the fibrous suspension passing through the tubular screen, the tubular screen having a predetermined diameter and an effective screening height, the predetermined diameter being at least 1.8 times greater than the effective screening height. Preferably, the predetermined diameter is at least 2 times greater than the effective screening height, preferably from 2.5 to 5 times greater than the effective screening height, more preferably at least 3 times greater than the effective screening height, and even more preferably at least 4 times greater than the effective screening height.

In accordance with one embodiment of the apparatus of the present invention, the tubular screen is stationarily mounted within the screen housing.

In accordance with another embodiment of the apparatus of the present invention, the tubular screen includes a surface and a predetermined height, the tubular screen including partial blinding means for covering a portion of the surface of the tubular screen whereby the predetermined height is greater than the effective screening height. Preferably, the partial blinding means comprises a solid, integral portion of the tubular screen which does not include any screen apertures. In another embodiment, the partial blinding means is welded to the outside surface of the tubular screen. In yet another embodiment, the partial blinding means is welded to the inside surface of the tubular screen.

In accordance with the present invention, a device has been developed in which the problem of thickening and wear is considerably reduced or entirely eliminated. It has thus been found by actual experimentation that the problems of thickening are substantially reduced when the dimensions of the screening member are changed so that the diameter of the screen member is made considerably greater than its height.

### BRIED DESCRIPTION OF THE DRAWINGS

The present invention may be more fully appreciated with reference to the following detailed description, which, in turn, refers to the accompanying drawings, in which:

FIG. 1 is a side, elevational, partially sectional view of a screening device including a screen member in accordance with the present invention;

FIG. 2 is a front, perspective view of a screening member in accordance with the present invention; and

FIG. 3 is a side, perspective view of another screening member in accordance with the present invention.

### DETAILED DESCRIPTION

The screening device shown in FIG. 1 comprises a pressurized screen housing 1, in which a stationary screening means 4 is located. Inside of the screening means 4 a rotary rotor means 2 is mounted on a rotor shaft 3. The rotor means 2 comprises wings 14 acting as pulse transmitting elements.

The screening means 4 divides the interior of the screen housing in the radial direction into an accept chamber 5 located outside the screen means 4 and a screen chamber 6, located inside the screening means 4.

The screening device further comprises inlet means 7 for the supply of a fibrous suspension to the screening device, at least one reject outlet means 8 for reject from the screening device, and at least one accept outlet means 9 for accept from the screening device.

The screening device also comprises a coarse reject outlet (a scrap trap) 10 for larger particles.

Through a dilution liquid inlet means 11 dilution liquid can be supplied to a dilution chamber 12. The need thereof, however, is reduced or potentially entirely eliminated by the present invention.

The screening means can be any type of screening means, with screening apertures of a suitable size to allow passage of the desired portion of the pulp suspension therethrough.

The screening means, for example, can have slits with openings between about 0.1 mm and about 0.5 mm, or holes with hole diameters between about 0.1 and 12 mm.

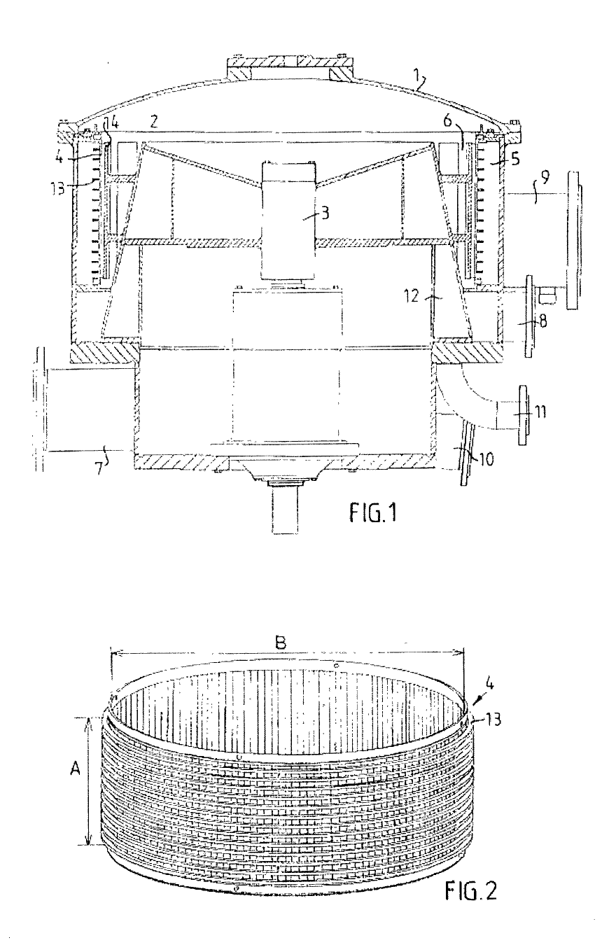

The height A of the screening means 4 in FIG. 2 relates to the effective screening height; i.e. to that portion of the screening means 4 where there are screening apertures. Thus, this effective screening height comprises the total height of the screen means and “blinded” portions of the screen, i.e. portions of the screen without any such holes or apertures. In general, the screen can then be blinded so that the blinded area is, for example, from about 25 to 75% or from about 40 to 60%, of the overall screen height (or of the total potential effective screening area) . The screening means 4 suitably also comprises support rings 13.

The diameter B relates to the inner diameter of the screening means, if the screening means 4 is intended for screening from the inside out, and its outer diameter, if the screening means 4 is intended for screening from the outside in.

The fibrous suspension to be separated is introduced through the inlet means 7 to the screen chamber 6 where the accepted fraction (the accept) flows through the screening means 4 into the accept chamber 5. When the fibrous suspension flows along the screening means in the direction towards the reject outlet 8, the concentration of fibers in the screen chamber becomes higher and higher the closer to the reject outlet the fibrous suspension flows. This is due to the fact that the liquid (water) in the fibrous suspension separates to a higher degree along this path, and at the beginning of the screening path flows through the screening means 4 into the accept chamber 5. A certain thickening, thus, takes place.

In the embodiment shown, the diameter B is about 3 times greater than the height A. Due to the low height of the screening means 4, a problem with a large degree of thickening in the screening means 4 does not arise. The fibrous suspension has no time to thicken to too great an extent along the relatively short path.

The problem with thickening will, in fact, already decrease when the diameter B of the screening means is 1.8 times greater than the height A. The diameter B, however, advantageously can be 2 or even 2.5 times greater than the height A, and still more suitably 3 times or 4 times greater than the height A.

The diameter B, however, shall not be more than 10 times greater than the height A, or preferably not more than 5 times greater than the height A, because the screening means 4 in this case becomes so low, that all of the fibers which should flow through the screening means 4, do not have the time to do so. The screening device will then be given a low capacity.

It can thus be seen that the minimum flow limit for a particular screening basket is lowered in proportion to the degree to which the effective screening height is decreased. Conversely, the maximum flow limit is altered in the same manner. Thus, the overall interval in which a screening apparatus can work is altered in relationship to the extent to which the screening basket is blinded. For example, if a particular apparatus is designed for a flow of from 120 to 250 m³ per hour, the flow in that same apparatus when the screen basket is 50% blinded will then range from 60 to 125 m³ per hour. Similarly, when an apparatus is designed for a flow of from 200 to 800 m³ per hour, when the screen basket is half blinded the flow can range from 100 to 400 m³ per hour. Thus, the same apparatus can be used with an altered capacity from that for which it was originally designed in a very simple manner.

Typically, the diameter B of the screening means 4 is about 800 mm to about 1500 mm, and it has an effective screening height A of about 300 mm to about 600 mm. The diameter B, however, can also be from about 150 mm to about 3600 mm, and the height A can be from about 50 mm to about 2000 mm. The diameter B, for example, can be 800 mm, and the height A 300 mm; i.e., the diameter is about 2.7 times greater than the height A.

A screening means designed according to the present invention also has advantages from the point of view of strength as compared to screening means known in the art. The rods in a rod screening basket, for example, are no longer required to be so long, which from the point of view of strength, of course, is an advantage.

A screening means according to the present invention can also be obtained by modifying a screening means known in the art; i.e., by partially blinding the screening means so that a lower effective screening height is obtained. Thus, the relationship between the diameter of the screening means and the effective screening height increases; i.e., the effective screening height A is obtained in which a higher screening means is partially blinded. Also, when the screening means is partially blinded, the rotor required in the screening apparatus can now also be reduced in height. The use of a shorter rotor, in turn, permits one to reduce the overall energy consumption with such a device.

The screening means 4 is thereby partially blinded so that an effective screening height A is obtained which is less than the original height of the screening means 4 so that the diameter B becomes at least 1.8 times greater than the effective screening height A.

The diameter B, however, can advantageously be 2 or even 2.5 times greater than the height A, and still more suitably 3 times or 4 times greater than the height A. The diameter B, however, shall not be more than 10 times greater than the height A, or preferably not more than 5 times greater than the height A

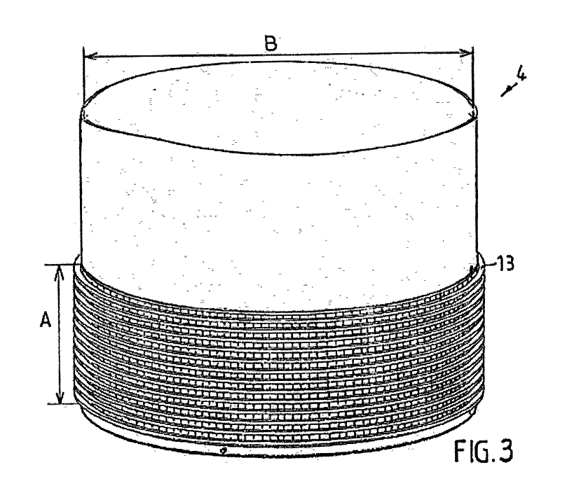

By partially blinding an existing screening means in a screening device, it is possible, without rebuilding the screening device or investing in a new screening device, to obtain a screening device which works much better. For example, referring specifically to FIG. 3 herein, the screening means 4 is a conventional screen which includes a screening area with an effectual screening height A. This screening area can also include support rings 13, as shown in FIG. 2. However, in this case the upper portion of the screening means 4 is blinded, in this case by having a solid portion devoid of any holes or slots effectively covering portions of the total potential effective screening area thereof. This portion does not, of course, necessarily need to comprise the upper portion of the screening means, but can comprise the lower portion, the central portion, or any combination thereof. A screening means in accordance with the present invention can thus be made by manufacturing the screening member as shown in FIG. 3 so that a portion of the overall screening surface is manufactured as a solid portion, without screening holes or slots of any kind. As an alternative, however, a conventional screening basket can be converted into the screening means in accordance with the present invention in a rather simple manner. The screening means shown in FIG. 3 can then include a plate welded to the outer surface thereof. This device would be used, for example, in situations where the fibrous solution is fed from the outside of the screen basket to the inside thereof. On the other hand, however, the plate can be welded to the inner surface of the screening means 4, preferably in those situations where the fibrous solution is being fed from the inside of the screening means 4 to the outside thereof. In an alternative, the blinded portion, whether integral or welded to the surface of the screening means, is located in the middle portion thereof. This embodiment can thus be used where the fiber suspension is fed to the middle portion of the screening means. One portion of the fiber suspension is then fed upwardly and another is fed downwardly for screening through the upper and lower screening portions thereof.

It is also noted that in the type of screening device shown in FIG. 1, it is preferable to blind the upper portion of the vertically disposed screening basket as shown in the device of FIG. 3. That is, in this case, since the fibrous solution is fed from the top or inlet end of the screening means 4 as well as from the inside out through the screening means 4, if the lower portion of the screening means or screening basket is blinded, there will then be a zone or chamber between the blinded portion of the screening basket and the rotor in which unscreened suspension can become lodged or stuck. One solution to this problem would be to close off this area to prevent any suspension from reaching it in the first instance. However, the preferable solution is to blind the upper portion of the screen basket as discussed above. The zone between the blinded portion of the screen basket and the rotor itself will then serve as a transport channel. In addition, another embodiment of the screening device of the present invention can be envisioned in which, instead of the embodiment as shown in FIG. 1, the screening basket is horizontally disposed as opposed to vertically disposed. In that embodiment, it would not be the “upper” portion of the screening basket which would preferably be blinded, but the inlet end thereof.

It should also be noted that by having available a number of different screening baskets for a single screening device, each of the baskets having a different effective screening height but the same overall height, such as by including different amounts of blinding on each basket, etc., the same screening device can then be used for different flows through the screening apparatus by merely substituting a different screening basket, with comparably good results.

A screening device can comprise more than one screening step.

The screening device can also be designed so that the screening means is intended to be rotary.

The screening device and the screening means can also be designed so that the fibrous suspension is intended to flow from the outside in through the screening means.

The accept outlet means, reject outlet means and inlet means can also be located in places other than those indicated in the embodiment shown herein. The number of accept outlet means and reject outlet means and their location is determined by the design of the screening device and by the number of screening steps it contains.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Apparatus for use in screening devices for separating a fibrous suspension, said apparatus comprising a tubular screen having a surface, predetermined height, a predetermined diameter and an effective screening height, said predetermined diameter being at least 1.8 times greater than said effective screening height and said tubular screen including partial blinding means for covering a portion of said surface of said tubular screen whereby said predetermined height is greater than said effective screening height.

2. The apparatus of claim 1 wherein said predetermined diameter is at least 2 times greater than said effective screening height.

3. The apparatus of claim 1 wherein said predetermined diameter is from 2.5 to 5 times greater than said effective screening height.

4. The apparatus of claim 1 wherein said predetermined diameter is at least 3 times greater than said effective screening height.

5. The apparatus of claim 1 wherein said predetermined diameter is at least 4 times greater than said effective screening height.

6. The apparatus of claim 1 wherein said partial blinding means comprises an integral, solid portion of said tubular screen which does not include any screen apertures.

7. The apparatus of claim 1 wherein said partial blinding means is welded to the outside surface of said tubular screen.

8. The apparatus of claim 1 wherein said partial blinding means is welded to the inside surface of said tubular screen.

9. Apparatus for separating a fibrous suspension comprising a screen housing, a tubular screen disposed within said screen housing, a rotatable rotor disposed within said screen housing for rotation therein, said rotatable rotor including pulsing means for providing pulses of said fibrous suspension to said tubular screen, inlet means for providing said fibrous suspension to said rotatable rotor, and outlet means for an accept portion of said fibrous suspension passing through said tubular screen, said tubular screen having a surface, a predetermined height, a predetermined diameter, and an effective screening height, said predetermined diameter being at least 1.8 times greater than said effective screening height and including partial blinding means for covering a portion of said surface of said tubular screen whereby said predetermined height is greater than said effective screening height.

10. The apparatus of claim 9 wherein said predetermined diameter is at least 2 times greater than said effective screening height.

11. The apparatus of claim 9 wherein said predetermined diameter is from 2.5 to 5 times greater than said effective screening height.

12. The apparatus of claim 9 wherein said predetermined diameter is at least 3 times greater than said effective screening height.

13. The apparatus of claim 9 wherein said predetermined diameter is at least 4 times greater than said effective screening height.

14. The apparatus of claim 9 wherein said tubular screen is stationarily mounted within said screen housing.

15. The apparatus of claim 9 wherein said partial blinding means comprises an integral solid portion of said tubular screen which does not include any screen apertures.

16. The apparatus of claim 9 wherein said partial blinding means is welded to the outside surface of said tubular screen.

17. The apparatus of claim 9 wherein said partial blinding means is welded to the inside surface of said tubular screen.
